(19) United States
(12) Patent Application Publication
(10) Pub. No.: US 2007/0140460 A1
(43) Pub. Date: Jun. 21, 2007

(54) Directory service in communication networks

(75) Inventors: Yigang Cai, Naperville, IL (US); Simon Xu Chen, QingDao (CN); Alexander Aihao Yin, QingDao (CN)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/312,175

(22) Filed: Dec. 20, 2005

(51) Int. Cl. H04M 3/42

(52) U.S. Cl. 379/218.01

(57) ABSTRACT

Communication networks, phones, and associated methods are disclosed that provide directory services to users of phones. A phone displays a directory search screen to a user, and the user enters one or more directory search parameters. The phone generates a request message that includes the directory search parameter(s), and transmits the request message to a communication network (e.g., a wireless network or a VoIP network). An application server in the communication network receives the request message, and queries a directory server based on the directory search parameter(s). The application server receives directory search results from the directory server, and transmits a response message to the phone that includes the directory search results. The phone then displays the directory search results to the user.

### BACKGROUND OF THE INVENTION

1. Field of the Invention

The invention is related to the field of communication networks, and in particular, to providing directory services in communication networks to allow users of phones to search for phone numbers, email addresses, etc.

2. Statement of the Problem

Voice over Internet Protocol (also called VoIP, IP Telephony, Internet telephony, and Digital Phone) is the routing of voice conversations over the Internet or any other Internet Protocol (IP)-based network. The voice data flows over a general-purpose packet-switched network, instead of over traditional dedicated, circuit-switched voice transmission lines. VoIP service generally allows for lower cost phone calls, especially for long distance calls. Many commercial service providers are offering VoIP service, and many enterprises (e.g., large companies, colleges, etc) are deploying their own VoIP networks.

The end user VoIP devices may be dedicated VoIP phones (also referred to as hard phones) or general purpose computers executing software that simulates a real phone (also referred to as soft phones). These VoIP devices, referred to generally herein as VoIP phones, typically have an LCD display and a keypad as a user interface. The VoIP devices also typically provide a “phone book” function that allows a user to store one or more phone numbers and associated information locally in the device. The phone numbers are typically entered and updated by the user. To subsequently place a call, the user accesses the phone book list and selects one of the phone numbers stored in the VoIP phone. The VoIP phone then places a call to the selected phone number.

One problem with the present phone book functions of VoIP phones is that there are storage limitations as to the number of phone numbers that can be stored locally on the VoIP phone. This is especially a problem for VoIP hard phones. Another problem is that once phone numbers are stored in the VoIP phone, the user has the burden of updating the phone numbers if they happen to change.

The following example illustrates the problems of present VoIP phones. Assume that a user has a VoIP phone for an enterprise VoIP network providing the communications for a large enterprise. The enterprise may have thousands of employees. Because of the storage limitations of the VoIP phone, the user would most likely not be able to store the phone numbers for all of the employees of the enterprise. Even if the VoIP phone allowed for storage of all of the numbers, employees of the enterprise may be changing, or may be moved to different locations that change their phone numbers. The user would have a heavy burden of updating the phone numbers locally stored in the VoIP phone.

Because it is not feasible to store the phone numbers of the employees locally in the VoIP phone, the user will unfortunately have to spend additional effort manually querying the phone number for an unfamiliar employee within the enterprise. There are various manual query methods, such as calling the enterprise operator, looking up the phone number in an enterprise phone book, or searching for the phone number in the enterprise computer network from the intranet web pages, via Microsoft exchange server, etc.

Enterprise phone numbers are normally stored on an enterprise Lightweight Directory Access Protocol (LDAP) server. The enterprise LDAP server can also store employee business information such as email addresses, business units, office locations, etc. Presently, some servers, such as an email server, can interface with the enterprise LDAP server to find entries of phone numbers, email addresses, etc. Unfortunately, VoIP phones and VoIP networks are not presently configured to allow VoIP phones to access the enterprise LDAP server and search the directory information.

Similar problems exist for commercial VoIP phones and VoIP networks.

Similar problems also exist for wireless phones and wireless networks, as directory services are not presently available in wireless networks.

### SUMMARY OF THE SOLUTION

The invention solves the above and other related problems by configuring a phone and a communication network to provide directory services. The phone is configured to receive directory search parameters from a user, and include the directory search parameters in a request message. Responsive to receiving the request message, an application server in the communication network recognizes the directory search parameters in the request message, and queries a directory server with the search parameters. The application server receives directory search results from the directory server, and provides those search results to the phone. The phone may then display the search results to the user. The search results may be phone numbers, email addresses, etc.

Advantageously, a user of a phone has access to multiple directory servers to find phone numbers, email addresses, etc. The phone does not need to store a large volume of phone numbers in a local “phone book” function, as the phone can query the network on-demand to receive the directory services. Also, the administrators of the directory servers are tasked with updating the phone numbers, email addresses, and other information in the directory server. Thus, the user of the phone would not have to worry about updating a voluminous amount of locally-stored data.

In one embodiment of the invention, a phone is adapted to display a directory search screen to a user. The user enters one or more directory search parameters into the phone. The phone generates a request message that includes the directory search parameter(s), and transmits the request message to a communication network. The phone subsequently receives a response message from the communication network that includes directory search results based on the directory search parameter(s). The phone then displays the directory search results to the user.

In another embodiment, a communication network includes an application server adapted to receive a request message from a phone, where the request message includes one or more directory search parameters entered by the user of the phone. The application server queries a local or remote directory server based on the directory search parameter(s). The application server receives directory search results from the directory server, where the directory search results comprise one or more phone numbers, email addresses, and/or associated information found based on the directory search parameter(s). Responsive to receiving the directory search results, the application server generates a response message that includes the directory search results, and transmits the response message to the phone for display of the search results to the user.

The invention may include other exemplary embodiments described below.

### DESCRIPTION OF THE DRAWINGS

The same reference number represents the same element on all drawings.

FIG. 1 illustrates a communication network in an exemplary embodiment of the invention.

FIG. 2 is a flow chart illustrating a method of operating a phone in an exemplary embodiment of the invention.

FIG. 3 is a flow chart illustrating a method of operating a communication network in an exemplary embodiment of the invention.

FIG. 4 is a flow chart illustrating a method of further operating a phone in an exemplary embodiment of the invention.

FIG. 5 illustrates a VoIP network in another exemplary embodiment of the invention.

FIG. 6 illustrates an exemplary search screen provided to a user by a VoIP phone.

FIG. 7 illustrates an exemplary SIP REGISTER message.

FIG. 8 illustrates an exemplary SIP 200 OK message.

FIG. 9 illustrates an exemplary search results screen provided to a user by a VoIP phone.

### DETAILED DESCRIPTION OF THE INVENTION

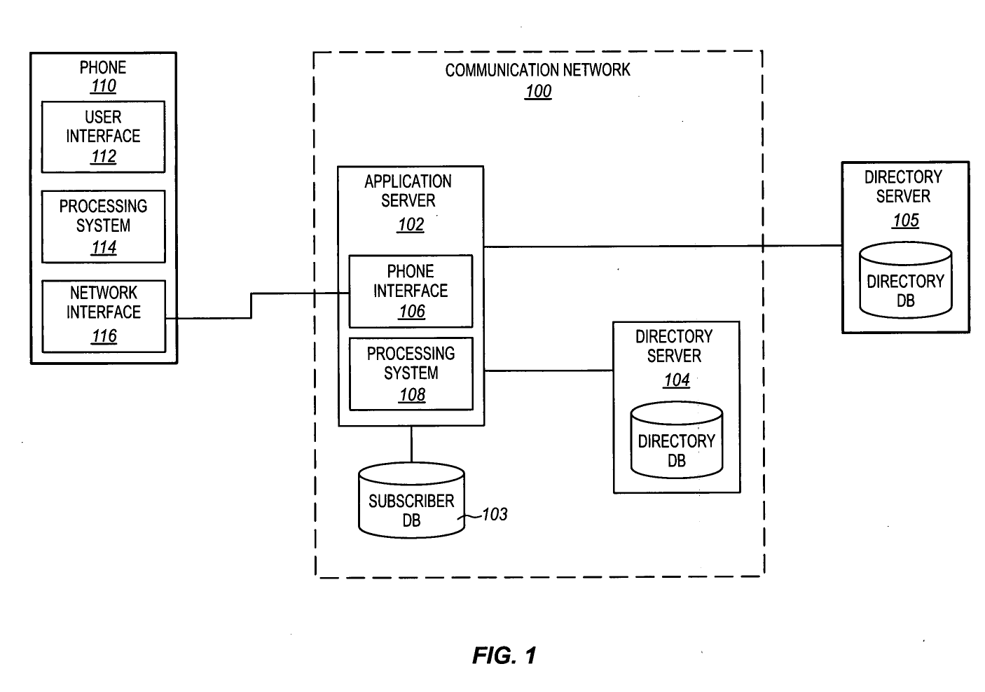

FIGS. 1-9 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise a packet-based network configured to provide voice communications, such as an IP Multimedia Subscriber (IMS) network or any other type of VoIP network. Communication network 100 may alternatively comprise a wireless network configured to provide wireless voice communications. Communication network 100 includes an application server 102, a subscriber database 103, and a directory server 104. Application server 102 is adapted to communicate with a phone 110 and a plurality of other phones (not shown). There may be other intermediate systems, routers, etc, between application server 102 and phone 110 that are not shown in FIG. 1. Application server 102 is also adapted to communicate with a directory server 105. Communication network 100 may include other networks, systems, or devices not shown in FIG. 1.

Application server 102 is a system that sets up, manages, and tears-down calls. Application server 102 manages phone 110 and other phones that register with it, and stores information on the phones being managed in subscriber database 103. If communication network 100 comprises a VoIP network, then application server 102 may comprise a VoIP application server. If communication network 100 comprises an IMS network, then application server 102 may comprise an application server and/or a Home Subscriber Server (HSS). If communication network 100 comprises a cellular or wireless network, then application server 102 may comprise a Mobile Switching Center (MSC) or similar system. In this embodiment, application server 102 includes a phone interface 106 and a processing system 108.

The phones being managed by application server 102 register with application server 102. For instance, when phone 110 is turned on, it registers with application server 102 by transmitting a registration message to application server 102. The registration message may comprise a SIP REGISTER message in SIP-based applications, or may be another message in other applications. Application server 102 loads data for phone 110 in subscriber database 103, such as the IP address of phone 110, the phone number for phone 110, etc. Periodically, phone 110 re-transmits registration messages to application server 102 so that phone 110 can retain its “registered” status.

Directory server 104 and directory server 105 comprise any systems or servers that store directory information, such as phone numbers, email addresses, and/or associated information. Directory servers 104-105 may store residential phone numbers, business phone numbers, etc. Directory server 104 is illustrated as part of communication network 100 (or local to application server 102). The purpose of this is to show that a service provider operating communication network 100 may maintain a directory server 104. For instance, if communication network 100 comprises an enterprise VoIP network, then directory server 104 represents the enterprise directory server of the enterprise. An enterprise directory server can be used to store employee business information, such as phone numbers, email addresses, business units, office locations, etc. If communication network 100 is operated by a commercial VoIP service provider, the service provider may choose to create and maintain directory server 104 to offer a directory service to their subscribers.

Directory server 105 is illustrated as outside of communication network 100. The purpose of this is to show that application server 102 may communicate with remote directory servers not owned or maintained by the service provider. For instance, directory server 105 may comprise a public or commercial directory server on the Internet that is available to Internet users. There are many local and nationwide yellow pages directory servers and white pages directory servers available on the Internet that store directory information.

Directory servers 104-105 may comprise Lightweight Directory Access Protocol (LDAP) servers that store directory information centrally and provide directory services that can be accessed via the LDAP protocol.

Phone 110 comprises any communication device adapted to provide voice and/or data communications. Phone 110 may comprise a wireline VoIP phone, a wireless VoIP phone, or a non-VoIP wireless phone (e.g., a cell phone). If phone 110 comprises a VoIP phone, then phone 110 may initiate and terminate VoIP calls according to SIP protocol or another protocol. If phone 110 comprises a cell phone, then phone 110 may initiate and terminate calls according to SS7 protocol, IS-41 protocol, etc. In this embodiment, phone 110 includes a user interface 112, a processing system 114, and a network interface 116. User interface 112 may comprise a keypad, a display, a touch-screen, a pointing device, and/or any other interface.

According to features and aspects herein, phone 110 and communication network 100 are adapted to provide a directory service to a user (not shown) of phone 110. Assume that the user wants to call a party and he/she does not know the number of the party. Also assume that the user does not have the number of the party stored locally on phone 110. The user can thus access the directory service to find the number of the party.

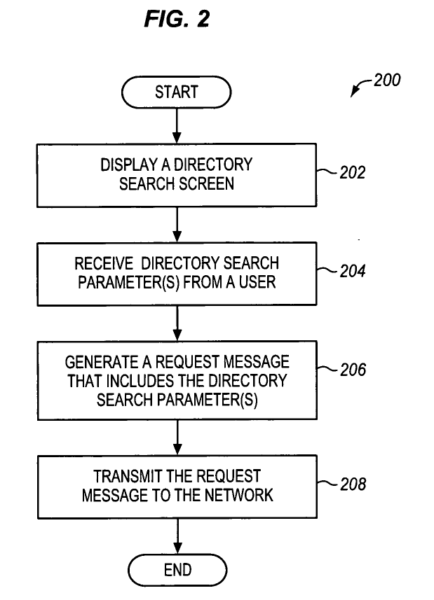

FIG. 2 is a flow chart illustrating a method 200 of operating phone 110 in an exemplary embodiment of the invention. The steps of method 200 will be described with reference to phone 110 in FIG. 1. The steps of the flow chart in FIG. 2 are not all inclusive and may include other steps not shown.

In step 202, user interface 112 displays a directory search screen to the user. The user enters one or more directory search parameters into phone 110, and user interface 112 receives the directory search parameter(s) in step 204. Directory search parameters comprise any identifying information used to search for a phone number. In other embodiments, directory search parameters may comprise any identifying information used to search for an email address, an Instant Message (IM) buddy name, etc. Directory search parameters may comprise a name (personal or business), an area code, a city, a state, a country, etc. For instance, a directory search parameter may be a last name, such as “Smith”. An additional directory search parameter may be a first letter of a first name, such as “A*”.

Responsive to receiving the directory search parameter(s), processing system 114 generates a request message in step 206. Processing system 114 includes the directory search parameter(s) in the request message. The request message may comprise a message conventionally used by phone 110 to update registration with communication network 100. One example of such a request message is a SIP REGISTER message used by VoIP phones to update registration with a VoIP network. In step 208, network interface 116 transmits the request message to communication network 100.

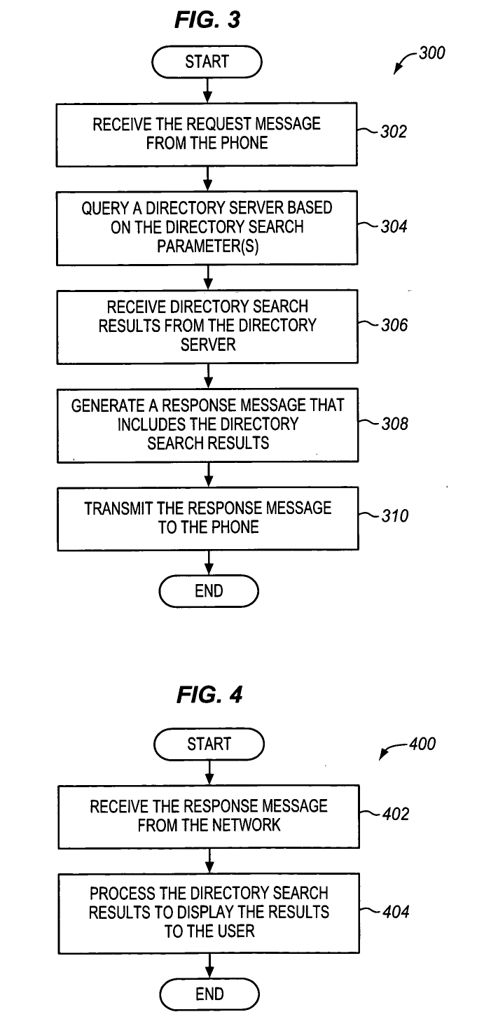

FIG. 3 is a flow chart illustrating a method 300 of operating communication network 100 in an exemplary embodiment of the invention. The steps of method 300 will be described with reference to communication network 100 in FIG. 1. The steps of the flow chart in FIG. 3 are not all inclusive and may include other steps not shown.

In step 302, phone interface 106 receives the request message from phone 110. As described above, the request message includes one or more directory search parameters entered by the user of phone 110. In step 304, processing system 108 queries a directory server 104-105 based on the directory search parameter(s). Processing system 108 may query either directory server 104 or 105, may query both directory servers 104-105, or may query other directory servers. For instance, processing system 108 may query subscriber database 103 to determine if any other currently registered subscribers match the-directory search parameter(s). Processing system 108 may additionally or alternatively query directory server 104 (if provided by the service provider) to determine if directory server 104 has any matches for the directory search parameter(s). Processing system 108 may additionally or alternatively query directory server 105 to determine if directory server 105 has any matches for the directory search parameter(s).

In step 306, processing system 108 receives directory search results from one of the directory servers 104-105. Directory search results comprise one or more records found based on the directory search parameters. A record may comprise a phone number and associated information, such as a name, address, etc. A record may alternatively comprise an email address and associated information. The directory search results may include a single record or a plurality of records. The number of records in the search results generally depends on the detail of the search parameter(s).

Responsive to receiving the directory search results, processing system 108 generates a response message in step 308. Processing system 108 includes the directory search results in the response message. The response message may comprise a message conventionally used by communication network 100 to respond to an update registration from phone 110. One example of such a response message is a SIP 200 OK message used by VoIP networks to acknowledge registration messages from a VoIP phone. In step 310, phone interface 106 transmits the response message to phone 110.

FIG. 4 is a flow chart illustrating a method 400 of further operating phone 110 in an exemplary embodiment of the invention. The steps of method 400 will be described with reference to phone 110 in FIG. 1.

In step 402, network interface 116 receives the response message from communication network 100. As described above, the response message includes directory search results based on the directory search parameter(s). In step 404, processing system 114 processes the directory search results to display the directory search results to the user through user interface 112. User interface 112 may display all of the search results or a subset of them. For instance, if the directory search results include a plurality of records, then user interface 112 may display the entire list of records or a subset of them. The number of records displayed may be set by the user, or may be set by filtering criteria used by processing system 114.

If multiple records are listed, user interface 112 allows the user to scroll through the search results. The user may then select one of the listed records, and initiate a call to the phone number of the record, save the record, edit the record, etc.

Communication network 100 and phone 110 advantageously provide a phone directory service to user that was not previously provided. If the user wants to search for a phone number, the user can enter search parameters into phone 110, and communication network 100 will obtain search results for the user. The user thus does not have to store and update a voluminous number on phone numbers locally in his/her phone 110.

The directory service provided by communication network 100 and phone 110 may be implemented in commercial applications and/or enterprise applications. The user of phone 110 may select whether the search is for an enterprise network or for a commercial communication network. If the search is for an enterprise network, then application server 102 would query an enterprise directory server within the enterprise. If the search is for a commercial network, then application server 102 would query one or more commercial directory servers.

### EXAMPLE

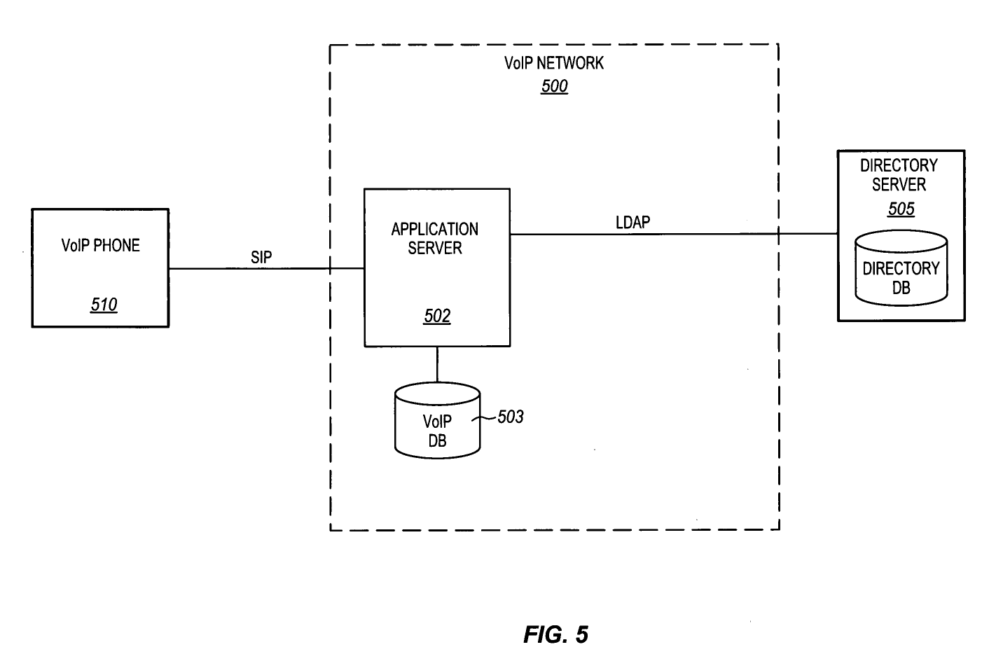

FIGS. 5-9 illustrate an example of using a directory service according to features and aspects herein.

FIG. 5 illustrates a VoIP network 500 in another exemplary embodiment of the invention. VoIP network 500 includes a VoIP application server 502 and a VoIP database 503. Application server 502 is adapted to communicate with a VoIP phone 510 and a plurality of other VoIP phones (not shown). The message protocol between application server 502 and VoIP phone 510 is SIP in this embodiment. Application server 502 is also adapted to communicate with a directory server 505. The message protocol between application server 502 and directory server 505 is LDAP. VoIP network 500 may include other networks, systems, or devices not shown in FIG. 5.

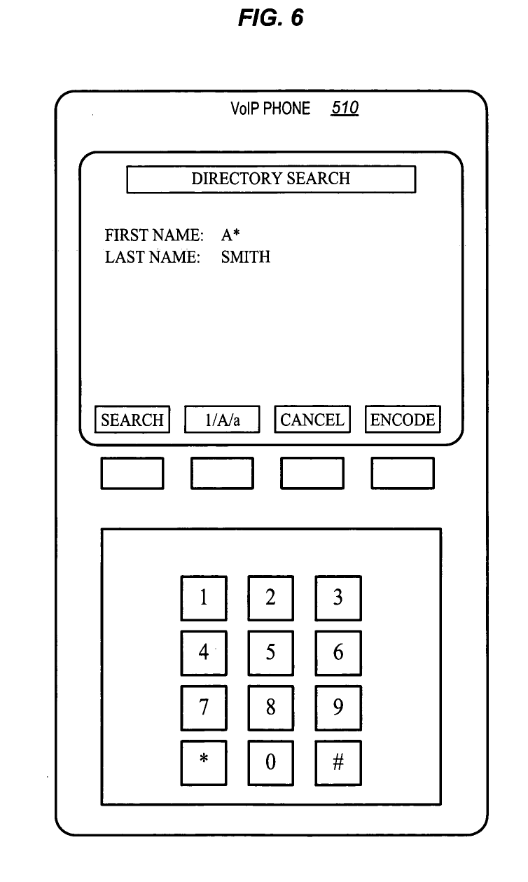

Assume that a user of VoIP phone 510 wants to call a party and he/she does not know the number of the party. To find the number, the user may access a directory search feature of VoIP phone 510. VoIP phone 510 displays a directory search screen to the user. FIG. 6 illustrates an exemplary directory search screen provided to the user by VoIP phone 510.

The user then enters one or more search parameters into VoIP phone 510 using the keypad (or other input mechanism). In this embodiment, the user has entered “A*” “Smith” as the search parameters. A button on VoIP phone 510 or an icon on the display of VoIP phone 510 may allow the user to switch the directory search between an enterprise VoIP network and commercial VoIP networks. Another button or icon on VoIP phone 510 may allow the user to switch the directory search between yellow pages or white pages.

Responsive to receiving the search parameters, VoIP phone 510 searches a locally-stored phone list first based on the search parameters. If not found in the locally-stored phone list, VoIP phone 510 initiates a directory search request by generating a SEP REGISTER message commonly used by VoIP phone 510 to periodically re-register with application server 502. VoIP phone 510 includes (or embeds) the search parameters in the SEP REGISTER message. VoIP phone 510 may also indicate in the REGISTER message the maximum results it can accept and the maximum seconds to wait for the search results. VoIP phone 510 then transmits the REGISTER message to VoIP network 500.

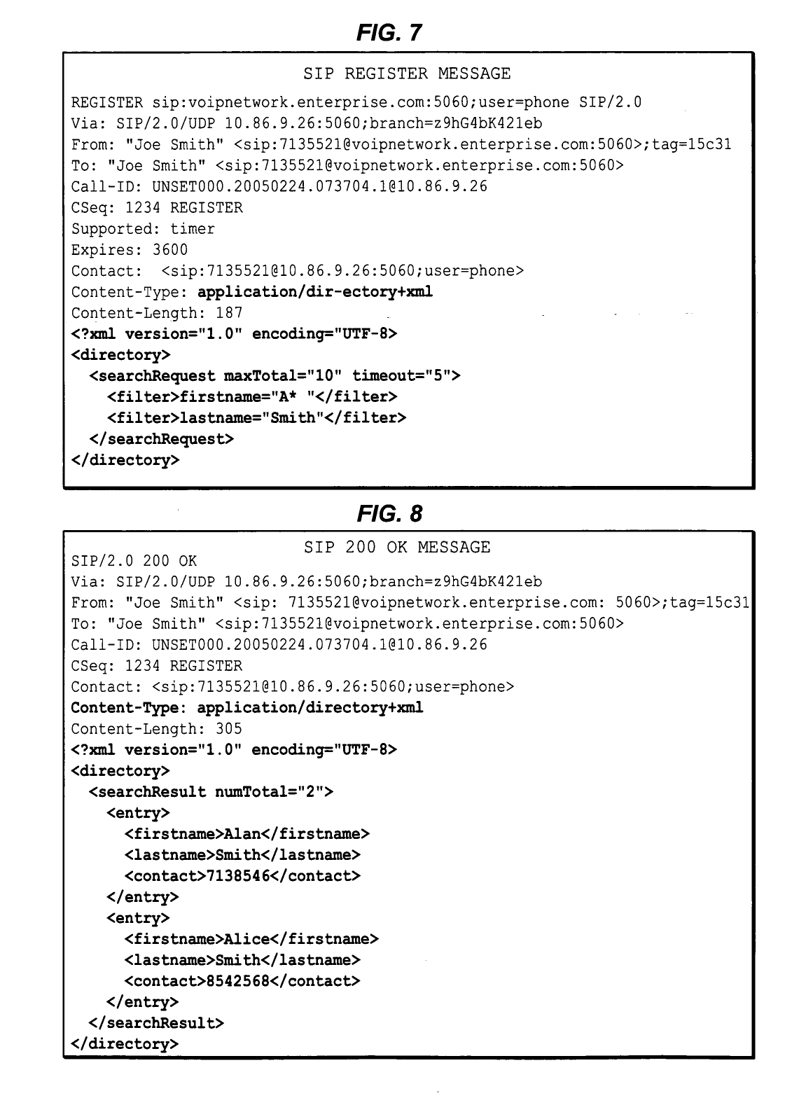

FIG. 7 illustrates an exemplary SIP REGISTER message. The search parameters are provided in XML data in a new content type defined as “application/directory+xml”. Looking at the XML data, the maximum number of records in the search results is 10, and the time out is 5 seconds. One of the search parameters is a first name of “A*”. The other search parameter is a last name of “Smith”.

In FIG. 5, application server 502 parses the XML body content of the REGISTER message to identify the search parameters. Application server 502 maps the search parameters to an LDAP search request, and transmits the LDAP search request to directory server 505. The directory server queried by application server 502 may depend on whether the user selected an enterprise directory search, a commercial directory search, a yellow pages search, a white pages search, etc. Another option is that application server 502 searches its own VoIP database 503 and returns the query result directly.

Responsive to an LDAP search request, directory server 505 performs a directory search based on the search parameters (“A*”, “Smith”). Directory server 505 transmits an LDAP search entry message back to application server 502. Directory server 505 also transmits an LDAP search result message back to application server 502 indicating the search results.

Application server 502 collects and parses the search results and generates a 200 OK message. Application server 502 includes the search results in the XML body of the 200 OK message. If the number of records listed in the search results exceeds the maximum number allowed, the rest of the results are dropped. Application server 502 transmits the 200 OK message to VoIP phone 510.

FIG. 8 illustrates an exemplary 200 OK message. The search results include two records as provided in XML data in the 200 OK message. The first record is for Alan Smith at the number 713-8546. The second record is for Alice Smith at the number 854-2568.

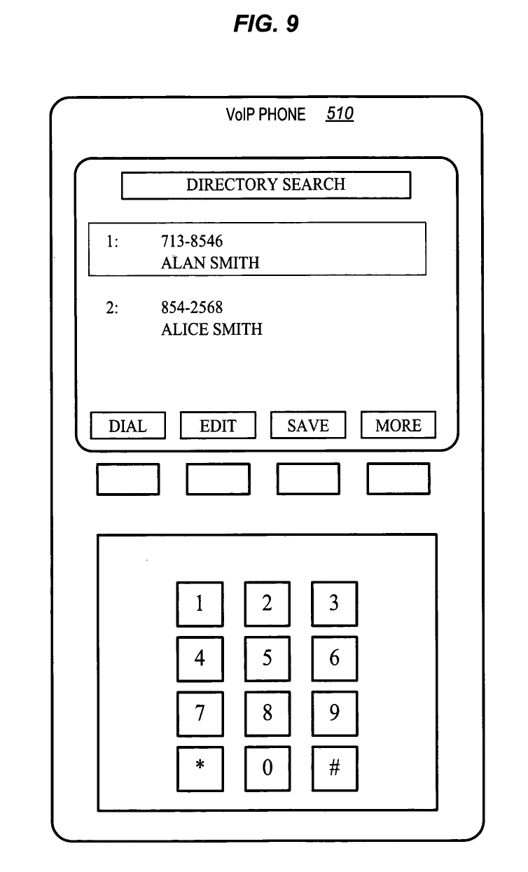

In FIG. 5, VoIP phone 510 parses the XML body content of the 200 OK message and displays the search results to the user. FIG. 9 illustrates an exemplary search results screen provided to the user by VoIP phone 510. VoIP phone 510 displays both records of the search results. VoIP phone 510 allows the user to scroll through the two records and select a particular record. The user may then initiate a call to the phone number of the selected record. The user may also edit the selected record, save the selected record, etc.

If no matching search results were found (the number of search results from application server 502 is 0), or VoIP phone 510 times-out waiting for the search results, then VoIP phone 510 displays “No matching records” or something similar. Any delayed search results from application server 502 are ignored.

Although specific embodiments were described herein, the scope of the invention is not limited to those specific embodiments. The scope of the invention is defined by the following claims and any equivalents thereof.

We claim:

1. An application server of a communication network for providing a directory service, the application server comprising:
a phone interface that receives a request message from a phone, wherein the request message includes at least one directory search parameter entered by the user of the phone; and
a processing system that queries a directory server based on the at least one directory search parameter, receives directory search results from the directory server, and generates a response message, wherein the response message includes the directory search results to be displayed to the user of the phone;
the phone interface transmits the response message to the phone.

2. The application server of claim 1 wherein the directory search results include at least one record, wherein a record includes a phone number and an associated name.

3. The application server of claim 1 wherein the processing system queries the directory server of an enterprise or queries the directory server of a commercial directory provider.

4. The application server of claim 1 wherein the phone comprises a VoIP phone.

5. The application server of claim 4 wherein:
the phone interface receives a SIP REGISTER message from the VoIP phone that includes the at least one directory search parameter; and
the phone interface transmits a SIP 200 OK message to the VoIP phone that includes the directory search results.

6. The application server of claim 1 wherein the directory server is local to the application server.

7. The application server of claim 1 wherein the directory server is remote from the application server.

8. The application server of claim 1 wherein the application server queries the directory server by mapping the directory search parameters to a Lightweight Directory Access Protocol (LDAP) search request.

9. A method of operating a communication network to provide directory services to a user of a phone, the method comprising:
receiving a request message from the phone, wherein the request message includes at least one directory search parameter entered by the user of the phone;
querying a directory server based on the at least one directory search parameter;
receiving directory search results from the directory server; and
transmitting a response message to the phone, wherein the response message includes the directory search results to be displayed to the user of the phone.

10. The method of claim 9 wherein querying a directory server comprises:
querying an enterprise directory server of an enterprise or querying a commercial directory server.

11. The method of claim 9 wherein the directory server comprises a Lightweight Directory Access Protocol (LDAP) server.

12. The method of claim 9 wherein the directory search results include at least one record, wherein a record includes a phone number and an associated name.

13. The method of claim 9 wherein the phone comprises a VoIP phone.

14. The method of claim 13 wherein:
receiving a request message from the VoIP phone comprises receiving a SIP REGISTER message that includes the at least one directory search parameter; and
transmitting the response message to the VoIP phone comprises transmitting a SIP 200 OK message that includes the directory search results.

15. A VoIP phone adapted to provide directory services to a user, the VoIP phone comprising:
a user interface adapted to display a phone directory search screen to the user and receive at least one directory search parameter from the user;
a processing system adapted to generate a registration message that includes the at least one directory search parameter; and
a network interface adapted to transmit the registration message to a VoIP network;
the network interface further adapted to receive a response message from the VoIP network that includes directory search results based on the at least one directory search parameter;
the processing system further adapted to process the directory search results to display the directory search results to the user through the user interface.

16. The VoIP phone of claim 15 wherein the directory search results include at least one record, wherein a record includes a phone number and an associated name.

17. The VoIP phone of claim 16 wherein the processing system is further adapted to:
receive a selection by the user of one of the at least one record; and
initiate a call to the phone number of the selected record.

18. The VoIP phone of claim 16 wherein the processing system is further adapted to:
receive a selection by the user of one of the at least one record; and
allow the user to save or edit the selected record.

19. The VoIP phone of claim 15 wherein the registration message comprises a SEP REGISTER message and the response message comprises a SEP 200 OK message.

20. The VoIP phone of claim 15 wherein the VoIP phone is wireless or wireline.
